(19) United States
(12) Patent Application Publication
(10) Pub. No.: US 2021/0254694 A1
(43) Pub. Date: Aug. 19, 2021

(54) HYDRODYNAMIC LAUNCH DEVICE WITH ANTI-EXPANSION FEATURE

(71) Applicant: EXEDY GLOBALPARTS CORPORATION, Belleville, MI (US)

(72) Inventor: Scott BINDER, South Lyon, MI (US)

(21) Appl. No.: 17/251,627

(22) PCT Filed: Jun. 13, 2019
(86) PCT No.: PCT/US2019/037030

§ 371 Date: Dec. 11, 2020

Related U.S. Application Data
(60) Provisional application No. 62/684,372, filed on Jun. 13, 2018.

(51) Int. Cl. F16H 41/24; F16H 45/02

(52) U.S. Cl. CPC F16H 41/24; F16H 45/02; F16H 2045/0278; F16H 2045/0221; F16H 2045/0205

(57) ABSTRACT

A launch device coupling the rotary output of a prime mover to the rotary input of an automotive transmission. The launch device includes a shell defining a chamber into which impeller blades extend. A rotatable turbine is located in the chamber. Turbine blades oppose the impeller blades and receive fluid from the impeller blades, causing rotation of the turbine and an output hub. Pull bearings constructively support the shell for relative rotation with respect to one or more internal components of the launch device, such as the output hub. Portions of the pull bearings are fixed relative to an associated one of the internal components to limit axial movement of the inner and outer races of the pull bearing and, thereby, limit axial expansion of the shell.

### BACKGROUND

### 1. Field of the Invention

The present invention generally relates to launch devices used in connection with automotive vehicle powertrains. More specifically, the invention relates to a launch device, such as a torque converter, used in connection with an automatic transmission of an automotive vehicle.

### 2. Description of Related Art

Generally, vehicles with automatic transmissions utilize a torque converter, or launch device, to couple the output of the engine or motor with the input of the automatic transmission. The torque converter is connected to the flex plate of the engine/motor and rotates with the flex plate. This rotation drives the impeller (also sometimes referred to as a pump) of the torque converter, which may be formed unitarily or integrally with the torque converter's shell or cover. The impeller includes blades (or vanes) that drive a fluid retained within the shell. Driven by the impeller, the fluid is transferred from the blades of the impeller to the blades of a turbine, causing rotation of the turbine. This rotational output of the turbine is then coupled to the input of the automatic transmission.

To enable torque multiplication, a stator is located between the impeller and the turbine. The stator, which is mounted on a one-way clutch, redirects fluid from the turbine back to the impeller. This redirection of the fluid is conducted in such a manner that it results in a multiplication of the torque.

Presented in FIG. 1 is a torque converter 900 of a construction similar to that discussed above. The torque converter 900 of FIG. 1 includes a front cover 902 with mounting studs 904 secured to cover's exterior surface. The studs 904 are used to mount the torque converter 900 to the flex plate (not shown) of an engine or motor (also not shown). At its periphery, the front cover 902 is secured to a rear cover 906.

Internally, the rear cover 906 is provided with a series of blades or vanes 908 so as to form the impeller 910. During rotation of the impeller 910, hydraulic fluid received through flow paths from the automatic transmission is centrifugally forced outward, then forward to impact against opposing blades 912 of the turbine 914. In FIG. 1, outward motion of the fluid is toward the top of the figure and forward motion of fluid is toward the left of the figure.

The shape of the turbine's blades 912 causes both rotation of the turbine 914 and redirection of the fluid. This redirection is both inward and back to the impeller 910. The turbine 914 is also mounted to a hub 916, which is in turn mounted to an input shaft (not shown) of the automatic transmission.

Positioned between the lower portions of the blades 908 of the impeller 910 and the blades 912 of the turbine 914 is a stator 918. The stator 908 receives hydraulic fluid being returned to the impeller 910 and redirects the fluid. This redirection is conducted in such a manner that it does not impede rotation of the impeller 910.

Forward of the turbine, between the turbine 914 and the front cover 902, the torque converter 900 also includes a rotational damper 920 and a lockup clutch assembly 922, of which the lockup clutch assembly 922 is forward most on the engine side of the torque converter 900.

Relative rotation between hubs of the rear cover 906, stator 918 and turbine 914 is permitted in the torque converter 900 by inclusion of axial thrust bearings, which may include roller balls or cylinders as the rolling elements.

During operation of the torque converter 900, as the engine speed increases, the fluid pressure inside the torque converter 900 similarly increases. Along with the increased fluid pressure, the hydrodynamic function of the fluid coupling between the impeller 910 and the turbine 914 causes the components within the torque converter 900 to experience an axial thrust load causing them to axially separate. This separation in turn causes the overall package of the torque converter shell 924, formed by the front and rear covers 902, 906 to expand or balloon. In some applications, the torque converter 900 may expand up to 2 mm. Since this expansion must be accommodated on both the engine and transmission sides of the torque converter, a total of 4 mm of axial expansion must be accounted for in protecting the torque converter 900.

To control this expansion, the front and rear covers 902, 906 are provided with a thickness that is sufficient to limit overall expansion to typically not more than 2 mm. The specific thickness of the front and rear covers 902, 906 depends on the particular application in which the torque converter 900 is used. However, in all applications, the increased thickness increases both the weight and the package size of the torque converter 900, which is contrary to the design optimization of the torque converter 900.

### SUMMARY OF THE INVENTION

In overcoming the drawbacks and limitations of the known technology, launch device's embodying the principles of the present invention allow for light weighting and package size reduction while still controlling the expansion of the launch to not more than 2 mm. Through the teachings of the present disclosure, expansion of the torque converter can be controlled while allowing for a decrease in the thickness of the front and rear covers, resulting in the above-mentioned weight and package size reduction.

In one aspect of the invention, a launch device is provided including features that limit axial expansion of the launch device's shell.

In another aspect, a launch device is provided for coupling the rotary output of a prime mover to the rotary input of an automotive transmission. The launch device includes a front cover configured for connection to the rotary output of the prime mover, and a rear cover fixedly connected to the front cover and rotatable with the front cover. The front cover and the rear cover cooperate to form a shell defining chamber. Extending into the shell is an impeller having a plurality of impeller blades and being connected to one of the front and rear covers. A turbine is located in the shell and being supported for rotation relative to the shell. The turbine includes a plurality of turbine blades generally opposing the impeller blades and shaped to receive fluid from the impeller blades thereby causing rotation of the turbine. The turbine blades also redirect the fluid back toward the impeller. An output hub is rotatably supported with in the shell and coupled to the turbine wherein rotation of the turbine causes rotation of the output hub about a central axis. The output hub is configured to connect with the rotary input of the automotive transmission. A plurality of pull bearings constructively support the shell for relative rotation with respect to one or more internal components of the launch device. The pull bearings each include a rolling element between inner and outer races. Portions of the pull bearings are fixed relative to an associated one of the internal components of the launch device and limit axial movement of the inner and outer races relative to one another along the central axis, thereby limiting axial expansion of the shell.

In another aspect, one of the pull bearings constructively supports the front cover relative to first internal component of the launch device.

In a further aspect, one of the pull bearings constructively supports the rear cover relative to first of the internal components.

In an additional aspect, a first pull bearing constructively supports the front cover relative to a first internal component of the launch device, a second pull bearing constructively supports the rear cover relative to a second internal component of the launch device and a third pull bearing constructively supports the first internal component relative to the second internal component.

In still another aspect, the first internal component is the output hub.

In a further aspect, the first, second and third pull bearings are axial bearings.

In an additional aspect, the rolling elements are cylindrical elements.

In another aspect, the rolling elements are needle elements.

In yet a further aspect, the rolling elements are ball bearings.

In an additional aspect, the pull bearings are supported on a radial surface of the output hub.

In another aspect, the radial surface is in inner radial surface of the output hub.

In a further aspect, the pull bearings include portions axially fixed to the associated ones of the internal components by welds.

In still an additional aspect, the portions axially fixed to the associated ones of the internal components are inner and outer races of the pull bearings.

In yet another aspect, the pull bearings include portions axially fixed to the associated ones of the internal components by snap rings.

In still a further aspect, the portions axially fixed to the associated ones of the internal components are bearing supports, the bearing supports supporting the inner and outer races of the pull bearings.

In another aspect, the launch device further includes an isolation damper and a lockup clutch assembly, the isolation damper being supported with the turbine on the output hub.

In an additional aspect, a turbine isolation damper and a lockup clutch assembly are also provided, wherein the turbine isolation damper includes a free portion connected to free portion of the turbine and supporting the turbine therethrough.

In still another aspect, the free portion of the turbine isolation damper is coupled to a spring plate, and the spring plate is supported by the output hub.

### BRIEF DESCRIPTION OF THE DRAWINGS

FIG. 1 is an axial cross-sectional view of a torque converter in accordance with a known construction.

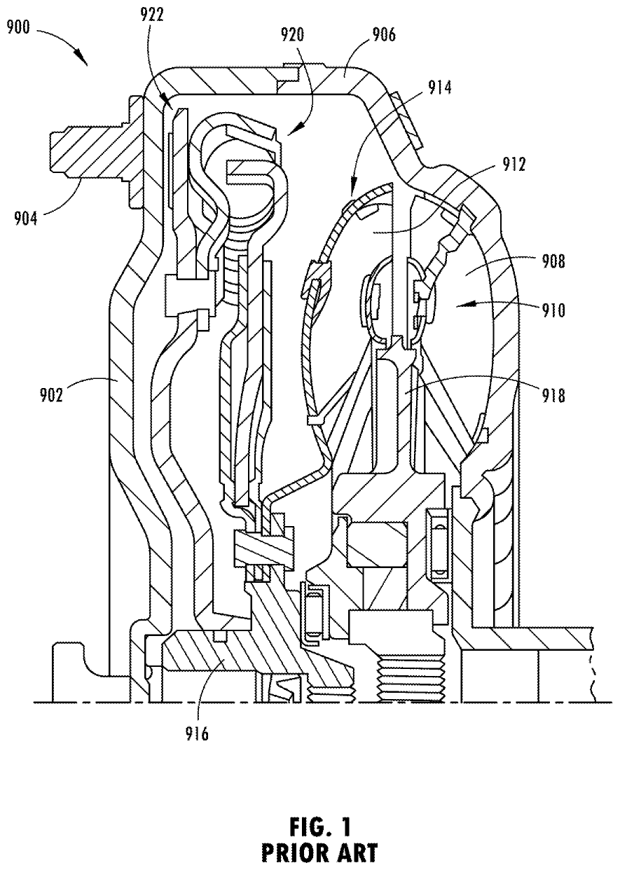

FIG. 2 is an axial cross-sectional view of a launch device embodying the principles of the present invention.

FIG. 3 is an axial cross-sectional view of a variation of a launch device embodying the principles of the present invention.

FIG. 4 is a partial, axial cross-sectional view of a further variation of a launch device embodying the principles of the present invention.

FIG. 5 is an axial cross-sectional view of a launch device embodying the principles of the present invention.

### DETAILED DESCRIPTION

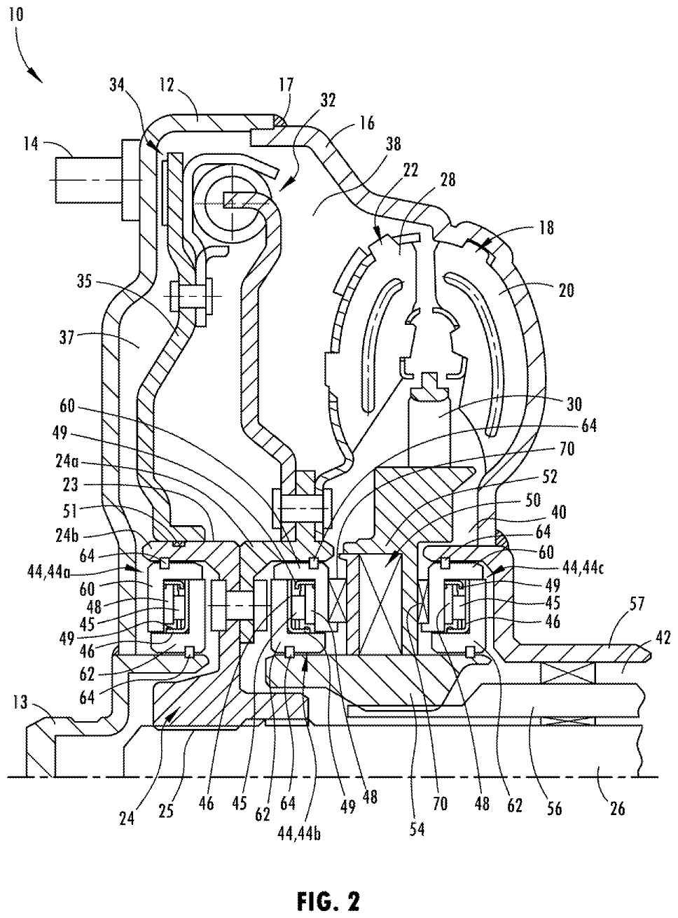

Referring now to the drawings, a launch device embodying the principles of the present invention is generally illustrated in, and will be described with reference to, the drawing seen in FIGS. 2-5. The description that follows may use directional terms such as “upper” and “lower.” These terms are intended to be read in the context of the orientation of the elements as presented in the drawing. Accordingly, “upper” indicates a direction toward the top of the drawing and “lower” indicates a direction toward the bottom of the drawing. The terms “left” and “right” are to be similarly interpreted. The terms “inward” or “inner” and “outward” or “outer” indicate a direction that is generally toward or away from a central axis of the referred to part, whether or not such an axis is designated in the drawing. Accordingly, an axial surface is one that faces in the axial direction. In other words, an axial surface faces in a direction along the axis. In contrast, a radial surface therefore faces radially, generally away from or toward the axis. It will be understood, however, that these relative terms are for convenience of description. In actual implementation of the device, the directional references used herein may not necessarily correspond with the installation and orientation of the corresponding components of the device.

Terms concerning attachment of structures and components, such as “coupled,” “attached,” “connected,” “joined,” “mounted” or “interconnected” refer to a relationship where the structures are secured or attached to one another either directly or indirectly through an intervening structure, unless specifically indicated otherwise. These attachments and relationships may be movable or rigid, unless indicated otherwise. “Integral” means that multiple elements are connected together so as to form one unit. “Unitary” means a single, one piece element. Thus, the term “unitary” is to be distinguished from the term “integral.”

Throughout the various figures, like elements are designated with like reference numerals to aid in understanding of the commonality of the like elements.

Referring now to FIG. 2, a launch device embodying the principles of the present invention is generally illustrated therein and designated at 10. The launch device 10 includes a front cover 12 having mounting studs 14, or similar features, spaced about its periphery and configured to connect the launch device 10 to a flex plate or outlet (not shown) of a prime mover (not shown), such as motor and including, without limitation, internal combustion engines and electric motors. At its radial periphery, the front cover 12 is secured to a rear cover 16, by welds 17 or other means, to define a fluid tight chamber therein. The front cover 12 defines the engine side of the launch device 10, while the rear cover 16 defines the transmission side of the launch device 10. Accordingly, as the flex plate is rotated by the crankshaft (not shown) of the prime mover, the front cover 12 and, therefore, the rear cover 16 are rotated in unison therewith.

Internally, the rear cover 16 is provided with a series of blades or vanes 20 so as to form an impeller 18. During rotation of the rear cover 16 and impeller 18, hydraulic fluid is supplied from the automatic transmission along a first pathway and is forced radially outwardly under the centrifugal force of the rotating impeller 18 and blades 20. The shape of the blades 20 and the inner surface of the rear cover 16 cooperate to further direct the hydraulic fluid toward of front cover 12. In FIG. 2, outward motion of the fluid is toward the top of the figure and the motion of fluid toward the front cover 12 is to the left of the figure.

Immediately forward of the impeller 18, the launch device 10 includes a turbine 22. The turbine 22 is mounted to a hub 24, and the hub 24 is connected to a rotatable input shaft 26 of the automatic transmission of the automotive vehicle. As seen in FIG. 2, the connection, designated at 25, between hub 24 and input shaft 26 is illustrated as a splined engagement. Also as seen in FIG. 2, the hub 24 is of a two piece construction including rigidly and integrally connected inner and outer hub flanges 24a and 24b, with the turbine 22 being secured to the inner hub flange 24a.

Similar to the impeller 18, the turbine 22 also includes a series of blades 28. The blades 28 of the turbine are oriented to receive the hydraulic fluid from the impeller 18, and the force of the hydraulic fluid from the impeller 18, in cooperation with the shape of the blades 28 of the turbine, rotationally drives the turbine 22. This rotation is in the same direction as the rotational direction of the impeller 18. Hydraulic fluid received by the turbine 22 is then redirected downward and rearward, back toward the impeller 18.

Position between the lower portions of the blades 20 of the impeller 18 and the blades 28 of the turbine 22 is a stator 30. The stator 30 receives the hydraulic fluid being returned from the turbine 22 toward the impeller 18. The stator 30 further redirects the fluid so that it is in the same rotational direction as the impeller 18. This redirection is conducted in such a manner that it is efficiently received by the impeller 18 and does not impede rotation of the impeller 18. With this fluid coupling, rotation from the output of the engine is transformed into rotation of the input shaft 26 of the automatic transmission.

Integrated with the stator 30 is a one-way clutch assembly 50 that limits the directional rotation of the stator 32 to a single direction. The one-way clutch assembly 50 includes an outer race 52, upon which the stator 30 is supported, and an inner race 54. The inner race 54 of the one-way clutch assembly 50 is mounted upon a fixed, nonrotating support shaft 56 associated with the input of the automatic transmission. In the interest of brevity and since one-way clutch assemblies are well known in the technological field of the present invention, the one-way clutch assembly 50 of the present launch device 10 is not and need not be explained in any greater detail herein. Those skilled in the art will really appreciate the construction and operation thereof.

Forward of the turbine 22, between the turbine 22 and the front cover 12, the launch device 10 includes an isolation damper 32. The isolation damper 32 is commonly mounted to the hub 24 with the turbine 22. The isolation damper 32 absorbs variations in the rotation speed of the front and rear covers 12, 18 to provide for smoother operation of the automatic transmission and the transmitting of less vibration to the occupant of the vehicle. Isolation dampers are well known in the technological field of the present invention. Accordingly, the isolation damper 32 of the launch device 10 is not discussed in detail herein, except as necessary.

Between the isolation damper 32 and the front cover 12, the launch device 10 additionally includes a lockup clutch assembly 34. The piston 35 of the lockup clutch assembly 34 is axially moveable so as to engage the inner surface of the front cover 12, which is effective to lock rotation of the input shaft 26 of the transmission with the rotation of the front cover 12. Like isolation dampers, lockup clutch assemblies of this type are well known in the technological field of the present invention. Accordingly, the lockup clutch assembly 34 is discussed herein as is necessary, but is not in significant detail herein.

During operation of the launch device 10, in the clutch open mode, hydraulic fluid is received along one or more passageways (not shown) formed in the input shaft 26 of the transmission, flows through bearing 44 and into a chamber 37 located between the piston 35 of the lockup clutch assembly 34 and the front cover 12. During this clutch open mode, pressure in this chamber 37 is greater than chambers elsewhere in the launch device 10, keeping the piston 35 spaced from the front cover 12 and keeping the lockup clutch assembly 34 open.

From chamber 37, fluid flows radially around the distal end of the piston 35 and into a circumferential chamber 38, generally defined between the radial or perimetric sides of the front and rear covers 12, 16 and the turbine 22. Some of this fluid passes from the circumferential chamber 38 into the hydrodynamic torus space between the impeller 18 and the turbine 22. This fluid operates with the impeller 18 and turbine 22 to define a fluid coupling within the launch device 10. Hydraulic fluid also passes from the fluid coupling into pathway 40, through another bearing 44 and exits the launch device 10 through a passage 42, defined between the non-rotation support shaft 56 and a hub 57 to which the rear cover 16 is fixedly secured.

Flow in the reverse direction initially operates to close the lockup clutch assembly 34. In this situation, pressure in the circumferential chamber 38 and between the turbine 22 and piston 35 is greater than pressure in chamber 37. As a result, the piston 35 axially moves along the outer radial surface 23 of an axial hub extension of the outer hub flange 24b. Once in the clutch closed mode, the only path of hydraulic fluid flow is leakage or seepage through the lining material of the lockup clutch assembly and/or various oil seals, such as the seal 51 between piston 35 and the outer radial surface 23 of the outer hub flange 24b.

It should be noted that the above described fluid flow is for the illustrated launch device 10. The exact fluid flow can and will vary based manufacturer preferences and the specific design criteria of the associated launch device.

As mentioned above, during operation of the launch device 10, engine speed increases. With this increase in engine speed, the axial forces and thrust loads generated by the hydrodynamic function of fluid coupling, as well as the increased fluid pressure within the launch device 10, will operate to cause axial expansion of the launch device 10.

To control and limit expansion induced by the hydraulic function and increased pressure, the launch device 10 of the present disclosure incorporates what are herein referred to as pull bearings 44. The integrated pull bearings 44 limit and/or prevent axial expansion of the launch devices shell by accepting the axial forces of the hydraulic function and increased pressure.

As seen in FIG. 2, the illustrated embodiment incorporates three axial pull bearings 44 for accommodating rotation between the various launch device subassemblies. The pull bearings 44 illustrated therein are of a needle bearing-type and incorporate cylindrical roller elements, needles, 45 between inner and outer races 46, 48 that are themselves captured between inner and outer bearing supports 62, 60. The inner and outer races 46, 48 of the pull bearings 44 are configured so as to resist axial loads compressing the races 46, 48 together, such as loads resulting from increases pressure within of the torque converter shell. As a result, the pull bearing 44 will continue operation under such forces.

As will be readily appreciated by those skilled in the technological field of this disclosure, the pull bearings 44 may adopt other configuration, such as being radially oriented or provided with different roller elements (such as ball bearings, etc.), so long as the above functionality is maintained. The above general construction applies to each of the pull bearings 44 discussed below.

A first one of the pull bearing 44a is constructively arranged between the front cover 12 and the hub 24 that supports the turbine 22. More specifically, the pull bearing 44a is positioned between an inner radial surface of the outer hub flange 24b and an outer radial surface of an alignment stub 13 that is fixedly secured to the front cover 12 via a weld or other means and that extends into the torque converter's shell. To position the pull bearing 44a, outer and inner bearing supports 60, 62 are respectively mounted via axial portions to the inner and outer radial surfaces of the outer hub flange 24b and the alignment stub 13, and retained by snap rings 64 located in corresponding grooves formed in the axial portions of the bearing supports 60, 62 and in the inner and outer radial surfaces of the outer hub flange 24b and alignment stub 13. The outer race 48 of the first pull bearing 44a is accordingly positioned on a radial portion of the outer bearing support 60 and the inner race 46 is positioned on a radial portion of the inner bearing support 62.

A second pull bearing 44b is arranged between the hub 24 supporting the turbine 22 and the hub forming the inner race 54 of the one-way clutch assembly 50. More specifically, the pull bearing 44b is positioned between an inner radial surface of the inner hub flange 24a and an outer radial surface of the inner race 54. Like the first pull bearing 44a, the second pull bearing 44b is positioned by outer and inner bearing supports 60, 62 respectively mounted via axial portions to the inner and outer radial surfaces of the inner hub flange 24a and the inner race 54 of the one-way clutch assembly 50, and retained by snap rings 64 located in corresponding grooves formed in the axial portions of the bearing supports 60, 62 and in the inner radial surface of the inner hub flange 24a and an outer radial surface of the inner race 54. The outer race 48 of the second pull bearing 44b is accordingly position on the radial portion of the outer bearing support 60 and the inner race 46 is positioned on the radial portion of the inner race 54.

A third pull bearings 44c is constructively arranged to between the impeller 18, including the rear cover 16, and the hub forming the inner race 54 of the one-way clutch assembly 50. More specifically, the pull bearing 44c is positioned between an outer radial surface of the and the hub forming the inner race 54 and an inner radial surface of an extension of the hub 57 to which the rear cover 16 is fixedly secured, via a weld or other means, and which extends into the torque converter's shell. To position the pull bearing 44c, outer and inner bearing supports 60, 62 are likewise employed and respectively mounted via axial portions thereof to the inner and outer radial surfaces of the hub 57 supporting the rear cover 16 and hub forming the inner race 54 of the lockup one-way clutch assembly 50. As with the prior pull bearings 44a, 44b, the outer and inner bearing supports 60, 62 of the third pull bear are secured with snap rings 64 located in corresponding grooves formed in the radial surfaces of the hub forming the inner race 54 and the inner extension of the hub 57. The outer race 48 of the third pull bearing 44s is accordingly positioned on the radial portion of the outer bearing support 60 and the inner race 46 is positioned on the radial portion of the inner bearing support 62.

While not discussed in detail herein, bushings 70, which may be plastic bushings, are provided laterally of the one-way clutch assembly 50, between the assembly 50 and the second and third pull bearings 44b, 44c, for additional lateral support. These bushings 70 assist in axially retaining the stator 30 in resistance to hydraulic forces exerted from the fluid flow between the impeller 18 and the turbine 22 during drive and coast maneuvers of the vehicle.

As a result of the pull bearings 44 and the construction provided herein, the launch device 10 is provided with a mechanism that limits the overall expansion of the launch device 10, while also allowing for the thickness of the front and rear covers 12, 16 to be reduced along with the overall axial packaging requirements of the launch device 10.

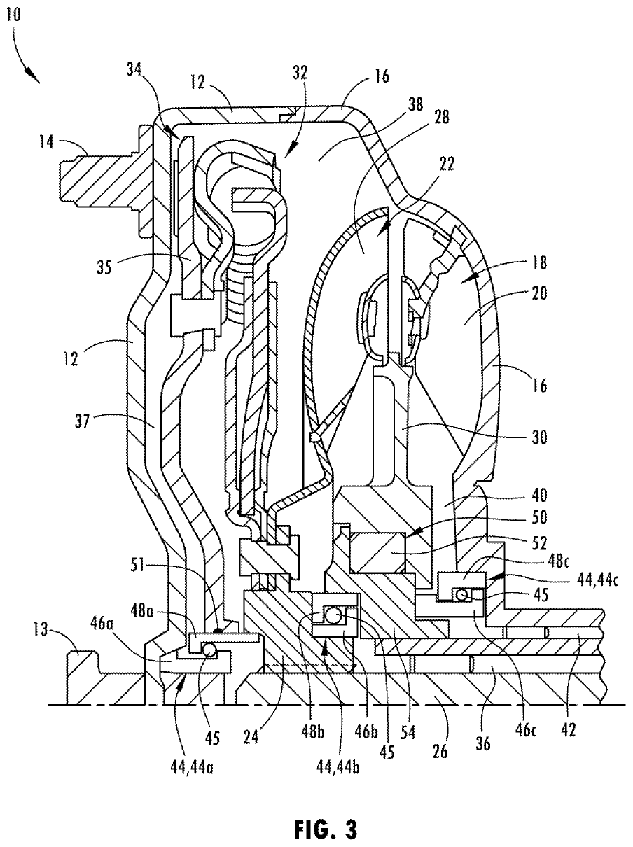

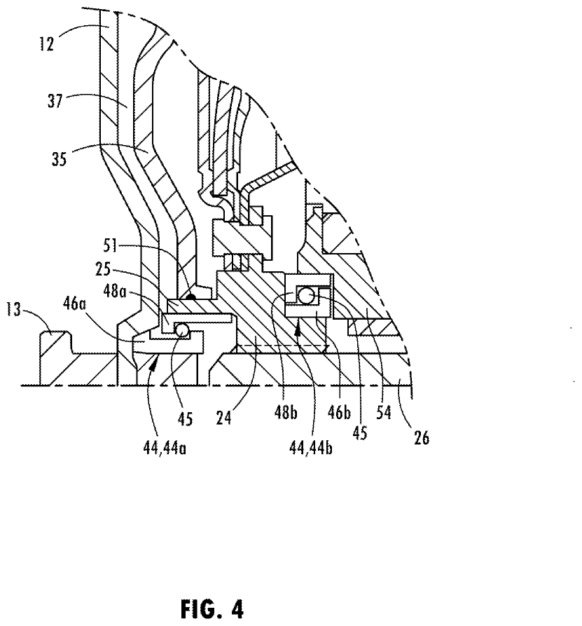

Referring now to the variation of the torque converter 10 of FIG. 3, the turbine 22 and the isolation damper 32 are supported on a unitary, one piece hub 24. Unlike the variation of FIG. 2, the bearing supports 60, 62 of the pull bearings 44 form the inner and outer races 46, 48, and the rolling elements 45 between the inner and outer races are ball bearings. The first pull bearing 44a is positioned between the front cover 12 and the hub 24 of the turbine 22 with the outer race 48a of the first pull bearing 44a being non-rotatably fixed to the hub 24, by welds or other means, and additionally serving as a race for axial movement of the piston 35 of the lockup clutch assembly 34. The inner race 46a in this variation is non-rotatably fixed, again by welds or other means, to the front cover 12 indirectly through the alignment stub 13, which is directly fixed to the front cover 12. The second pull bearing 44b in FIG. 4 is arranged between the hub 24 of the turbine 22 and the inner race 54 of the one-way clutch assembly 50. However, the inner race 46b of the second pull bearing 44b is non-rotatably fixed, by similar means, to an outer radial surface of the hub 24. The outer race 46a of the second pull bearing 44b is non-rotatably fixed, again by similar means, to an inner race 54 formed as part of the one-way clutch assembly 50.

A third pull bearing 44c of FIG. 3, like the variation of FIG. 2, is arranged between the inner race 54 of the one-way clutch assembly 50 and the impeller 18. However, as seen in FIG. 3, the inner race 46c is non-rotatably fixed to the inner race 54 of the one-way clutch assembly 50, and the outer race 48c is non-rotatably fixed to the impeller 18.

As can be imparted from the differences between FIGS. 2 and 3, the inner and outer races 46, 48 of the pull bearings 44 maybe mounted in accordance herewith on either axial surfaces (as seen in FIG. 2) or radial surfaces (as seen in FIG. 3) of the respectively associated components. Also, the non-rotatably fixation may be achieved through a variety of fixation mechanisms, including the use of various mechanical fits, including snap rings, or the use of welds.

A further alternative embodiment of the launch device 10 is seen in FIG. 4. The launch device 10 of FIG. 4 is identical to the launch device 10 of FIG. 3, except for the mounting and support of the piston 35. Instead of the outer race 48a of the first pull bearing 44a serving as the inner race of the piston 35, the hub 24 is provided with an extension 25 circumscribing the outer race 48a of the first pull bearing 44a. The extension 25 of the hub 24 serves as the inner race of the piston 35 of the lock-up clutch assembly 34. Accordingly, this aspect of the construction is similar to FIG. 2.

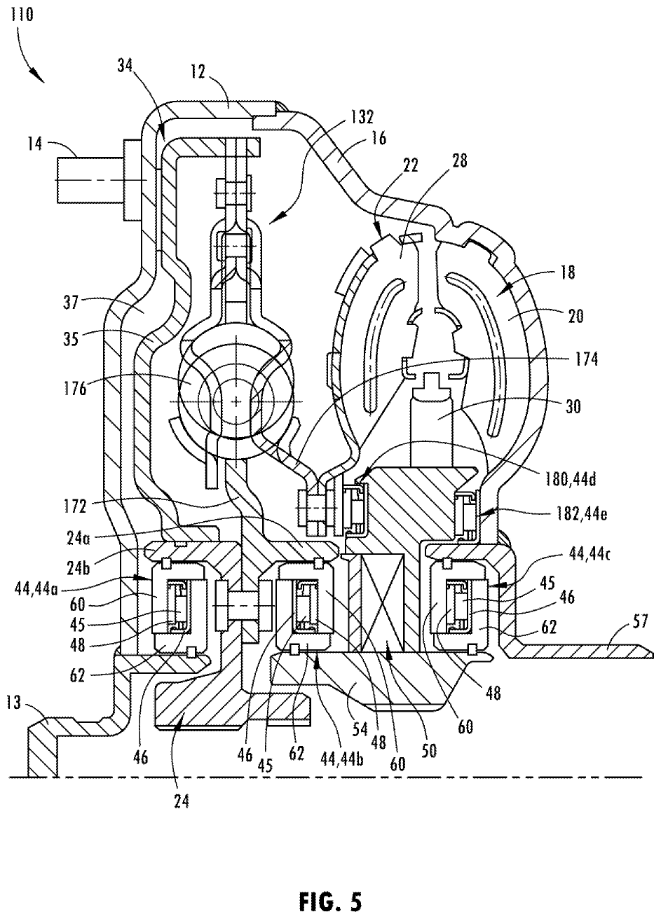

Referring now to FIG. 5, illustrated therein is a torque converter similar to the torque converter 10 seen in FIG. 2, with the principal difference being that the torque converter of FIG. 5 utilizes a turbine isolation damper 132 instead of the isolation damper 32 of FIG. 2. With incorporation of the turbine isolation damper 132, the flow of torque through the torque converter 110 is not from the turbine 22, to the hub 24 and to the input shaft 26 of the automatic transmission. Rather, the flow of torque through the torque converter 110 is from the turbine 22, to the turbine isolation damper 132, and to a spring plate 172 of the damper 132, which transfers the torque to the hub 24 and to the input shaft 26 of the automatic transmission the turbine 22. As such the turbine 22 is not mounted to the inner hub flange 24a of the hub 24. Rather, the turbine 22 is directly connected to an input plate 174 of the turbine isolation damper 132, which is also not mounted to the hub 24. Rotation of the turbine 22, therefore induces rotation of the damper's input plate 174, the input plate 174 is rotatably relative to the spring plate 172 and springs 176 between the two plates 172, 174 isolate the vibrational variations received from the turbine 22, before the spring plate 172 transfers torques to the hub 24 and input shaft 26. As further seen in FIG. 5, the spring plate 172 may be integrally or unitarily formed as part of the hub 24 itself.

With the construction seen in FIG. 5, the configuration of the pull bearings 44 (44a, 44b, 44c) is otherwise identical to the construction seen in FIG. 2. Accordingly, the discussion presented above regarding FIG. 2 is equally applicable to FIG. 5, herein incorporated by reference and therefore not unnecessarily repeated. Like elements are therefore designated in FIG. 5 with like reference numerals. Also in the interest of clarity, all of the common reference numerals are not repeated in FIG. 5, but are understood as being present via reference to FIG. 2.

With the turbine 22 not mounted to the hub 24, the stator 30 is more greatly impacted by hydraulic forces resulting from fluid flow between the impeller 18 and turbine 22 during drive and coast maneuvers of the automotive vehicle. As seen in FIG. 5, the stator 30 is axially supported and retained relative to the turbine 22 and rear cover 16 through incorporation of an axial bearing 180 therebetween. These bearing 180 may be, but need not be, a pull bearing 44 limiting axial movement between the turbine 22 and the stator 30 and rear cover 16. The bearings 180 need not be a pull bearing limiting axial movement because axial expansion in this area is not significantly impactful on the overall torque converter 110. Rather, the bearings 180 may be conventional axial bearings, such as the needle bearings shown in the figure.

As a person skilled in the art will readily appreciate, the above description is meant as an illustration of at least one implementation of a launch device incorporating the principles of the present invention. This description is not intended to limit the scope or application of this invention since the invention is susceptible to modification, variation and change without departing from the spirit of this invention, as defined in the following claims.

1. A launch device for coupling the rotary output of a prime mover to the rotary input of an automotive transmission, the launch device comprising:
a front cover configured for connection to the rotary output of the prime mover, a rear cover fixedly connected to the front cover and rotatable with the front cover, the front cover and the rear cover cooperating to form a shell defining chamber, an impeller having a plurality of impeller blades extending into the chamber and being connected to one of the front and rear covers;
a turbine located in the shell and being supported for rotation relative to the shell, the turbine including a plurality of turbine blades generally opposing the impeller blades, the turbine blades being shaped to receive fluid from the impeller blades thereby causing rotation of the turbine and to redirect the fluid back toward the impeller;
an output hub rotatably supported with in the shell and coupled to the turbine wherein rotation of the turbine causes rotation of the output hub about a central axis, the output hub being configured to connect with the rotary input of the automotive transmission;
a plurality of pull bearings located within the chamber defined by the shell, the pull bearings constructively supporting the shell for relative rotation with respect to one or more internal components of the launch device, the pull bearings each including a rolling element between inner and outer races, portions of the pull bearing being fixed relative to an associated one of the internal components of the launch device limiting axial movement of the inner and outer races relative to one another along the central axis and thereby limiting axial expansion of the shell.

2. The launch device according to claim 1, wherein one of the pull bearings constructively supports the front cover relative to first internal component of the launch device.

3. The launch device according to claim 1, wherein one of the pull bearings constructively supports the rear cover relative to first of the internal components.

4. The launch device according to claim 1, wherein the plurality of pull bearings includes a first pull bearing constructively supports the front cover relative to a first internal component of the launch device, a second pull bearing constructively supports the rear cover relative to a second internal component of the launch device and a third pull bearing constructively supports the first internal component relative to the second internal component.

5. The launch device according to claim 4, wherein the first internal component is the output hub.

6. The launch device according to claim 4, wherein the first, second and third pull bearings are axial bearings.

7. The launch device according to claim 4, wherein the rolling elements are cylindrical elements.

8. The launch device according to claim 4, wherein the rolling elements are needle elements.

9. The launch device according to claim 1, wherein the rolling elements are ball bearings.

10. The launch device according to claim 1, wherein the pull bearings are supported on a radial surface of the output hub.

10. The launch device according to claim 9, wherein the radial surface is in inner radial surface of the output hub.

11. The launch device according to claim 4, wherein the pull bearings include portions axially fixed to the associated ones of the internal components by welds.

12. The launch device according to any of claim 11, wherein the portions axially fixed to the associated ones of the internal components are inner and outer races of the pull bearings.

13. The launch device according to claim 4, wherein the pull bearings include portions axially fixed to the associated ones of the internal components by snap rings.

14. The launch device according to any of claim 13, wherein portions axially fixed to the associated ones of the internal components are bearing supports, the bearing supports supporting the inner and outer races of the pull bearings.

15. The launch device according to claim 1, wherein the launch device further includes an isolation damper and a lockup clutch assembly, the isolation damper being supported with the turbine on the output hub.

16. The launch device according to claim 1, wherein the launch device further includes a turbine isolation damper and a lockup clutch assembly, the turbine isolation damper including a free portion connected to free portion of the turbine and supporting the turbine therethrough.

17. The launch device according to claim 16, wherein the free portion of the turbine isolation damper is coupled to a spring plate, and the spring plate is supported by the output hub.
